(19) United States
(12) Patent Application Publication
(10) Pub. No.: US 2002/0084675 A1
(43) Pub. Date: Jul. 4, 2002

(54) Obstacle detection to the rear of a vehicle with a liftgate

(76) Inventors: Harry Charles Buchanan JR., Dayton, OH (US); Richard L. Ponziani, Centerville, OH (US)

Correspondence Address: Andrew R. Basile, Young & Basile, P.C., Suite 624, 3001 West Big Beaver Road, Troy, MI, 48084, US

(21) Appl. No.: 09/750,652

(22) Filed: Dec. 28, 2000

(51) Int. Cl. B60J 5/10

(52) U.S. Cl. 296/146.8

(57) ABSTRACT

The present invention is a method and apparatus of performing vehicle obstruction sensing during vehicle reverse and liftgate opening movements. The invention uses the same sensors to perform both functions. When the vehicle is in reverse, the invention produces a visible and/or audible signal to the operator of the vehicle when an obstruction detected within the monitoring range of the sensor or sensors. When the vehicle transmission is in any position other than park, the liftgate driver is disabled. When the vehicle is in park, the liftgate sensing system is enabled. The invention either stops the liftgate opening movement or reverses the liftgate movement when an obstruction is detected. The invention can also signal an alarm when an obstruction is detected in the path of the liftgate. The present invention incorporates any number of existing sensors.

### FIELD OF THE INVENTION

The invention relates in general to sensors located on a vehicle used to detect obstructions.

### BACKGROUND OF THE INVENTION

Vehicles with reverse sensing systems use one or more sensors on the rear bumper of the vehicle to sense obstacles to the rear of the vehicle while it is backing up. The sensors typically alert the driver through audible and/or visible indicators. In general, a reverse sensing system is only enabled when the vehicle gear select lever is in the “reverse” position.

Some vehicles are equipped with a power liftgate actuator system. In such systems, the liftgate is driven to the open position at the touch of a button. Vehicles with this system are at a risk of the liftgate colliding with outside obstacles and causing vehicle damage during the opening movement if the operator is not diligent at assuring that the liftgate path is clear of obstacles. Some software algorithms used to control the liftgate have sensing to react when an obstruction is encountered, then reverse or discontinue the drive power to the liftgate. This method does not prevent the damage from occurring, but only reacts after impact, thereby failing to eliminate the risk of vehicle damage.

What is needed is the ability to sense obstacles in the path of the liftgate prior to any contact with the liftgate and to automatically stop the opening movement of the liftgate when an obstacle is detected. Ideally, such a system should be integrated with the rear obstacle detector system.

### SUMMARY OF THE INVENTION

The present invention employs the sensors used for sensing objects when a vehicle is in reverse to also prevent vehicle damage when the power liftgate is activated. Specifically, the method for sensing an obstruction to the rear of a vehicle comprises the steps of disposing at least one sensor in the liftgate and generating a first signal when the sensor indicates an obstruction when the liftgate is opening. In another aspect of the invention, the method further comprises the step of generating a second signal when the sensor indicates an obstruction when the vehicle is reversing.

The apparatus of the present invention comprises at least one sensor disposed in the liftgate and means for generating a first signal when the sensor indicates an obstruction when the liftgate is opening. In another aspect of the invention, the apparatus further comprises means for generating a second signal when the sensor indicates an obstruction when the vehicle is reversing.

Preferably, the first signal sent from the controller when the sensor indicates an obstruction in the liftgate path could be either an audible and/or a visible alarm, or it could be a signal stopping or reversing the liftgate driver, typically a motor. The second signal sent from the controller when the sensor indicates and obstruction to the rear of the vehicle while it is reversing could be either an audible and/or a visible alarm.

In one aspect of the invention, the system disables the power liftgate driver when the vehicle is not in park.

Thus, the present invention, by locating the sensor or sensors at one or more locations on the liftgate, allows the sensors to remain functional as detectors for obstacles when the vehicle is reversing, continuing to activate appropriate warnings for the vehicle operator. Further, when the power liftgate is deployed, the sensor or sensors act as anticipators to prevent liftgate collisions with outside obstructions by stopping or reversing the liftgate or warning the vehicle operator.

### BRIEF DESCRIPTION OF THE DRAWINGS

The various features, advantages, and other uses of the present invention will become more apparent by referring to the following detailed description and drawings in which:

FIG. 1A is a pictorial diagram of a vehicle with a liftgate, which vehicle incorporates the present invention;

FIG. 1B is the rear view of the vehicle of FIG. 1A;

FIG. 2 is a data flow diagram of vehicle control components involved in carrying out the present invention; and

FIG. 3 is a flow diagram illustrating the method according to the present invention.

### DETAILED DESCRIPTION

Referring to FIGS. 1A and 1B, shown is a vehicle incorporating the present invention. The vehicle 10 includes a power liftgate 12 and a bumper 14. Disposed in the liftgate 12 is at least one sensor 16 located toward the bottom edge of the liftgate 12 near the bumper 14. In one aspect of the invention, one sensor 16 is disposed in the center of the liftgate 12. In another aspect of the invention, two sensors 16 are disposed in opposite corners of the liftgate 12 on the same horizontal plane. Although the invention is shown incorporating either one or two sensors 16, more than two sensors could be used. The number of sensors used is dependent on the field of view of the sensors. The sensors 16 should be placed so that their fields of view overlap and/or cover the entire length of the bumper 14 from end to end. Additional sensors could be located on the bumper 14 to perform sensing when the vehicle is reversing.

The sensors 16 are common sensors used for electronically sensing objects in the path of the sensors, which would indicate an obstruction to the vehicle on which the sensor is mounted. Such sensors 16 may be ultrasonic, charge coupled device (CCD) camera, radar, etc. A typical sensor includes a transceiver that transmits signals and subsequently receives signals reflected from an object in the sensor path. The reflected signals are emitted as a signal to a processor coupled to the transceiver, where the processor analyzes the received signal to detect the presence, and often the distance, of an obstruction. A conventional ultrasonic sensor typically emits ultrasonic waves utilizing the resonance phenomena exhibited by an ultrasonic resonator, and the resonator receives reflected waves from an object, which waves are analyzed by the processor. Similarly, a CCD camera emits light according to a predetermined wavelength and receives a reflection of that light for analysis. The radar sensor generally operates using transmission of a frequency modulated carrier signal. An example of a vehicle exterior object sensor is described in U.S. Pat. No. 5,844,471, which is incorporated herein by reference.

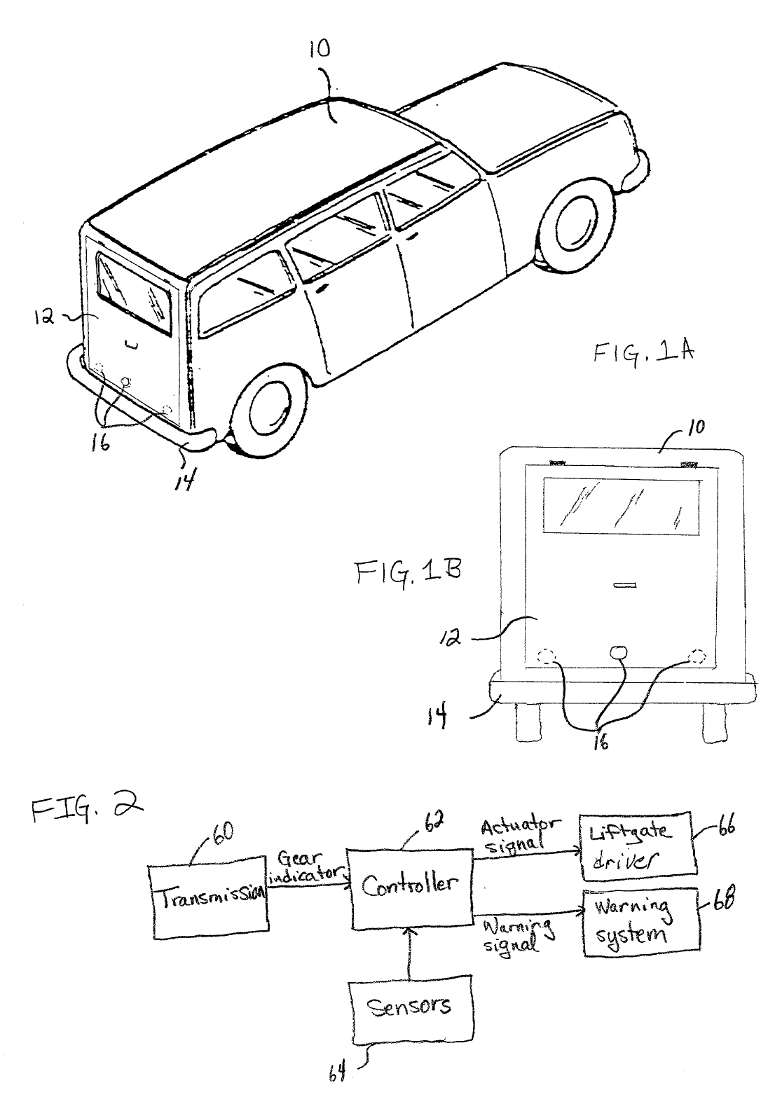

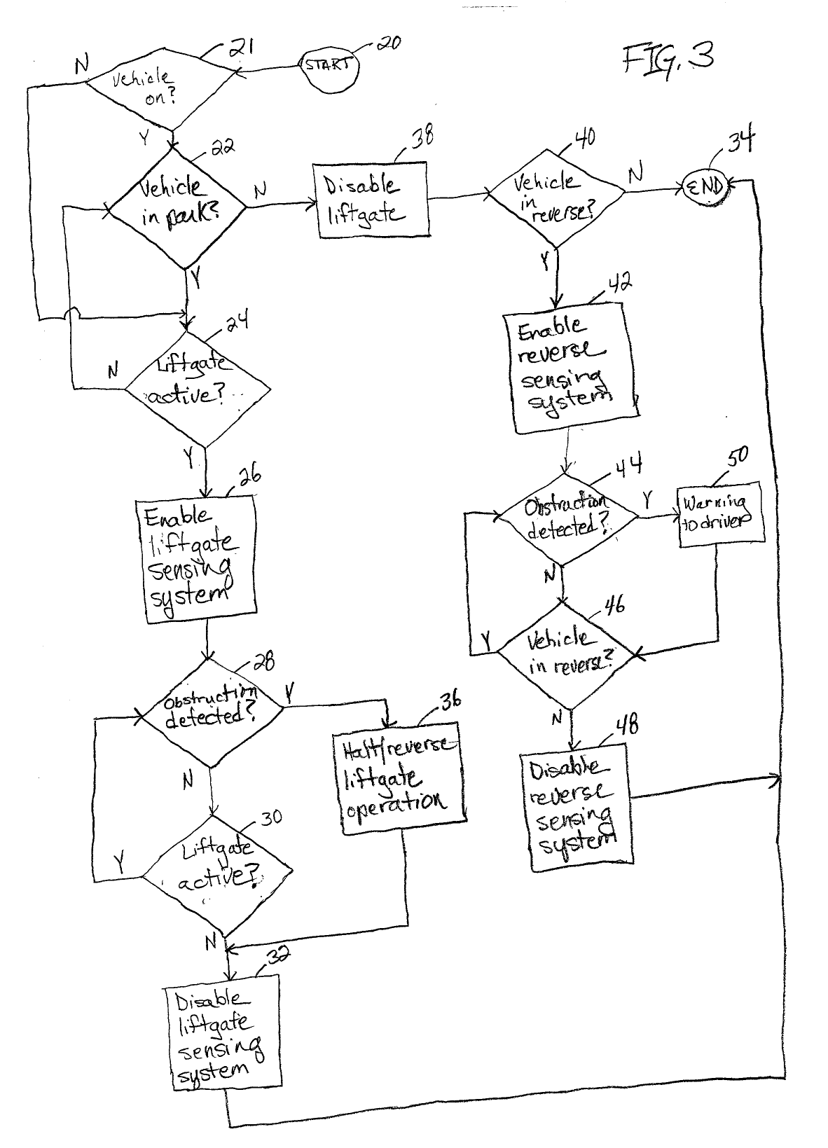

Referring now to FIG. 2, the engine controller 62 receives an indication of gear position. The controller 62 may be a conventional microcontroller which includes such elements as a central processing unit (CPU), read only memory, random access memory, input/output control circuitry, and analog to digital conversion circuitry. The controller 62 is activated upon application of ignition power to an engine. When activated, the controller 62 carries out a series of operations stored in an instruction-by-instruction format in memory for providing engine control, diagnostic and maintenance operations. Preferably, the transmission 60 of the vehicle provides the indication of gear position to the controller 62. Alternatively, the vehicle gear select lever provides the gear indication.

The sensors 16 provide signals 64 to the controller 62 indicating the presence of an object in the path of each sensor. The controller 62 receives and analyzes the signals 64 to determine whether an obstruction is present, requiring an actuator signal to a liftgate driver 66, usually a motor, or a signal to an automobile warning system 68 or both.

FIG. 3 shows how the sensors 16 are used to perform reverse sensing and liftgate damage avoidance according to the method of the present invention. The procedure starts at step 20 upon initialization of power to an engine controller 62. Then, the procedure makes a query as to whether the vehicle ignition is “on” or not in step 21. If the vehicle ignition is “on,” the procedure advances to step 22, where a query is made as to whether the vehicle is in park. If the vehicle is in park, the procedure advances to step 24. At step 24, a query is made as to whether the power liftgate 12 is active, which means that the liftgate driver 66 is energized. If the liftgate 12 is not active, then the procedure returns to step 22. If, however, the liftgate 12 is active, the procedure advances to step 26.

Returning now to step 21, if the vehicle ignition is not “on,” the procedure advances directly to step 24 to determine whether the power liftgate 12 has been activated.

Powered systems for opening and closing a vehicle liftgate are known in the art. Generally, such systems comprise a pair of drive units attached to the vehicle frame and connected to the liftgate. Each drive unit includes a bracket secured to the vehicle body, supporting several parts including a reversible electric driver, usually a motor, a gear train, a rack and a cradle mounted on the bracket. The electric driver drives the rack from a retracted position to an extended position and back via an output gear with an axis. The rack slides in the cradle, which cradle is pivotally mounted on the bracket so that the cradle pivots about the axis of the output gear to hold the teeth of the rack in engagement with the teeth of the output gear. The electric driver is controlled via electric motor controls, well known to those skilled in the art.

In step 26, the liftgate sensing system is enabled when the power liftgate is activated. The procedure then advances to step 28, where a query is made as to whether an obstruction has been detected by the sensors 16. If an obstruction has not been detected, i.e., an object is not within the range of view of a sensor 16, the sensors 16 continue to be monitored until the liftgate 12 is no longer activated, shown in step 30. If the liftgate 12 is activated, then the procedure returns to step 28 to determine if an obstruction is detected. If the liftgate 12 is no longer activated, then the procedure advances to step 32, where the liftgate sensing system is disabled. The procedure then ends at step 34.

Returning now to step 28, if an obstruction is detected by the sensors 16, then the procedure advances to step 36, where the operation of the liftgate is halted or reversed by an actuator signal provided to the electric driver 66 of the power liftgate actuator system. In one aspect of the invention, in addition to halting or reversing the operation of the liftgate, a warning could be transmitted to the driver, similar to the warning provided to the driver when an obstruction is detected by the reverse sensing system. The procedure advances to step 32, where the liftgate sensing system is disabled. Then, the procedure ends at step 34.

Returning now to step 22, if the vehicle is not in park, the procedure advances to step 38, where the power liftgate driver 66 is disabled. Next, a query is made in step 40 as to whether the vehicle is in reverse. If the vehicle is not in reverse, the procedure ends at step 34. If the vehicle is in reverse, then the procedure advances to step 42. In step 42, the reverse sensing system is enabled. In step 44, the query is made as to whether the sensors 16 have detected an obstruction. If an obstruction has not been detected in step 44, the procedure advances to step 46 where a query is made as to whether the vehicle is still in reverse. If the vehicle is still in reverse, the procedure returns to step 44 to check the sensors 16 for detected objects. If, however, the vehicle is no longer in reverse, then the procedure advances to step 48 where the reverse sensing system is disabled. The procedure then ends at step 34.

Returning now to step 44, if an obstruction is detected by the sensors 16, the procedure advances to step 50, where a warning is sent to the driver. The warning can be a visual and/or an audible alarm, conventional in the art. An audible alarm is generally a solid state piezoelectric alarm, while a visual alarm generally comprises a lamp or lamps lit or flashing when an obstruction is detected. Generally, the audible alarm sounds a warning of an obstruction that beeps faster and/or at a higher pitch as the vehicle approaches the obstruction. Similarly, the closer the obstruction is to a vehicle equipped with a visual alarm, the increasingly bright the lamp, or the faster the lamp flashes. After the warning is sent, the procedure returns to step 46 where a query is made as to whether the vehicle is in reverse. If the vehicle is still in reverse, the procedure returns to step 44 to check the sensors 16 for detected obstructions. If, however, the vehicle is no longer in reverse in step 46, the reverse sensing system is disabled in step 48. The procedure then ends at step 34.

The procedure runs continuously at predetermined intervals while engine power is on. When the engine is off, the procedure is performed when the liftgate 12 is activated.

The method and apparatus of the present invention provides a vehicle with a unique system that provides detection of obstructions while the vehicle is reversing, and also provides a sensing system to avoid liftgate damage. The invention uses the same sensors to perform both functions.

What is claimed is:

1. A method for sensing an obstruction to a rear of a vehicle having a liftgate, comprising the steps of:
disposing at least one obstruction sensor in the liftgate; and
generating a first signal when the sensor indicates an obstruction to the rear of the vehicle.

2. The method according to claim 1, wherein the liftgate is controlled by a liftgate driver, and wherein when the liftgate is opening the step of generating a first signal comprises at least one of the steps of:
activating a first alarm;
stopping the liftgate driver; and
reversing the liftgate driver.

3. The method according to claim 2, wherein the first alarm is one of an audible alarm and a visible alarm.

4. The method according to claim 1, wherein when the vehicle is reversing the step of generating the first signal comprises the step of activating a first alarm.

5. The method according to claim 4, wherein the first alarm is one of an audible alarm and a visible alarm.

6. The method according to claim 1, wherein the liftgate is controlled by a liftgate driver, and further comprising the step of:
disabling the liftgate driver when the vehicle is not in a park gear.

7. The method according to claim 1, wherein the liftgate is controlled by a liftgate driver and the step of generating the first signal comprises at least one of the steps of:
(A) activating a first alarm;
(B) stopping the liftgate driver; and
(C) reversing the liftgate driver; and
further comprising the step of:
generating a second signal when the sensor indicates an obstruction when the vehicle is reversing.

8. The method according to claim 7, wherein the step of generating a second signal comprises the step of activating the first alarm.

9. The method according to claim 7, wherein the step of generating a second signal comprises the step of activating a second alarm, which second alarm is one of an audible alarm and a visible alarm.

10. The method according to claim 7, further comprising the step of:
disabling the liftgate driver when the vehicle is not in a park gear.

11. An apparatus for sensing an obstruction to a rear of a vehicle with a liftgate, comprising:
at least one sensor disposed in the liftgate; and
means for generating a first signal when the sensor indicates an obstruction to the rear of the vehicle.

12. The apparatus according to claim 1, wherein the liftgate is controlled by a liftgate driver, and wherein when the liftgate is opening the means for generating a first signal comprises at least one of:
means for activating a first alarm;
means for stopping the liftgate driver; and
means for reversing the liftgate driver.

13. The apparatus according to claim 12, wherein the first alarm is one of an audible alarm and a visible alarm.

14. The apparatus according to claim 11, wherein when the vehicle is reversing the means for generating a first signal comprises means for activating a first alarm.

15. The apparatus according to claim 14, wherein the first alarm is one of an audible alarm and a visible alarm.

16. The apparatus according to claim 11, wherein the liftgate is controlled by a liftgate driver, and further comprising:
means for disabling the liftgate driver when the vehicle is not in a park gear.

17. The apparatus according to claim 11, wherein the liftgate is controlled by a liftgate driver and the means for generating a first signal comprises at least one of:
(A) means for activating a first alarm;
(B) means for stopping the liftgate driver; and
(C) means for reversing the liftgate driver; and further comprising:
means for generating a second signal when the sensor indicates an obstruction when the vehicle is reversing.

18. The apparatus according to claim 17, wherein the means for generating a second signal comprises means for activating the first alarm.

19. The apparatus according to claim 17, wherein the means for generating a second signal comprises means for activating a second alarm, which second alarm is one of an audible alarm and a visible alarm.

20. The apparatus according to claim 17, further comprising:
means for disabling the liftgate driver when the vehicle is not in a park gear.
